(19) United States
(12) Patent Application Publication
(10) Pub. No.: US 2023/0097383 A1
(43) Pub. Date: Mar. 30, 2023

(54) ELECTRIC TOOTHBRUSH HEAD AND ELECTRIC TOOTHBRUSH

(71) Applicant: GUANGZHOU STARS PULSE CO., LTD., Guangzhou (CN)

(72) Inventors: Xing WANG, Guangzhou (CN); Shihua LIU, Guangzhou (CN)

(21) Appl. No.: 17/834,217

(22) Filed: Jun. 7, 2022

Related U.S. Application Data
(63) Continuation of application No. PCT/CN2022/074759, filed on Jan. 28, 2022.

(30) Foreign Application Priority Data
Sep. 30, 2021 (CN) 202122411194.2
Sep. 30, 2021 (CN) 202122411239.6

(51) Int. Cl. A46B 7/04; A46B 9/04

(52) U.S. Cl. CPC A46B 7/04; A46B 9/04; A46B 2200/1066

(57) ABSTRACT

An electric toothbrush head and an electric toothbrush are provided. The electric toothbrush head includes a brush head body, bristles and a flexible member. The brush head body includes a brush rod and a brush plate. The brush plate is elastically deformable and has a non-deformed state and an elastically deformed state relative to the brush rod. An included angle between the brush plate and the brush rod is changeable within a range from 0 degrees to X degrees. The X degrees are equal to or greater than 10 degrees. The elastically deformed state includes a first deformed state in which the brush plate is bendable or deformable towards a front surface relative to the brush rod and a second deformed state in which the brush plate is bendable or deformable towards a back surface relative to the brush rod.

### CROSS-REFERENCE TO RELATED APPLICATIONS

The present application is a continuation of International Patent Application No. PCT/CN2022/074759, filed on Jan. 28, 2022, which claims priority to Chinese Patent Application No. 202122411194.2, filed on Sep. 30, 2021, and Chinese Patent Application No. 202122411239.6, filed on Sep. 30, 2021, the entire disclosures of which are incorporated herein by reference.

### FIELD

The present disclosure relates to the field of oral cleaning technologies, and more particularly, to an electric toothbrush head and an electric toothbrush.

### BACKGROUND

Electric toothbrushes are widely favored by users because the electric toothbrushes provide ease for use and labor-saving benefits and help accomplish good oral cleaning. Some electric toothbrushes in the related art achieve cleaning of teeth by the vibrating movement of a brush head. However, insufficient vibration amplitude generally results in poor cleaning strength. In the related art, amplitude/rotational speed/frequency of a motor is increased to enhance the cleaning strength. However, too large vibration amplitude/speed/frequency of the motor not only causes hand vibration, but also applies a large force to the teeth to render enamel scratched, failing to achieve a balance between cleaning strength and comfort of use.

### SUMMARY

The present disclosure aims to solve at least one of the problems in the related art. Accordingly, an objective of the present disclosure is to provide an electric toothbrush head, which brings increased amplitude without using a motor having a large amplitude, such that a hand vibration phenomenon caused by the use of the motor having the large amplitude can be avoided, at the same time, both excellent cleaning effect and comfortable handheld experience are realized.

The present disclosure also provides an electric toothbrush using the electric toothbrush head described above.

An electric toothbrush head according to an embodiment of a first aspect of the present disclosure includes: a brush head body, a plurality of bristles, and a flexible member. The brush head body includes a brush rod and a brush plate. The brush rod includes a first end and a second end that are opposite to each other in a longitudinal direction of the brush rod. The brush plate is connected to the first end of the brush rod. The brush plate includes a front surface and a back surface in a thickness direction of the brush plate. The brush plate is elastically deformable and has a non-deformed state and an elastically deformed state relative to the brush rod. An included angle between the brush plate and the brush rod is changeable within a range from 0 degrees to X degrees, where the X degrees are equal to or greater than 10 degrees. The elastically deformed state includes a first deformed state and a second deformed state. The brush plate is bendable or deformable towards the front surface relative to the brush rod in the first deformed state. The brush plate is bendable or deformable towards the back surface relative to the brush rod in the second deformed state. The second end of the brush rod is adapted to be connected to a brush handle of an electric toothbrush. The brush rod is configured to transmit vibration generated by the brush handle of the electric toothbrush to the brush plate. Each of the plurality of bristles includes a root portion and a head portion, which are respectively provided at two ends of each of the bristles along a longitudinal direction of the bristles. The root portion of each of the plurality of bristles is connected to the brush plate. The head portion of each of the plurality of bristles is configured to extend out from the front surface of the brush plate. A hardness of the flexible member is smaller than a hardness of the brush plate. The flexible member includes at least one of: a first flexible portion arranged on the back surface of the brush plate, a second flexible portion arranged on a peripheral side of the brush plate, or a third flexible portion arranged on the front surface of the brush plate.

According to the electric toothbrush head provided by the embodiment of the present disclosure, an included angle between the brush plate and the brush rod is changeable within a range from 0 degrees to X degrees, where the X degrees are equal to or greater than 10 degrees. On one hand, an amplitude of vibration of the electric toothbrush head can be increased. A reversed impact force from teeth is buffered through the elastic deformation of the brush rod. The amplitude can be increased to improve cleaning effect without using a higher-amplitude motor. Elastic soft vibration is realized to soften a force applied to the teeth and avoid the problem of vibrating the hand, and thus the cleaning effect and the comfortable handheld experience are both realized. On the other hand, the flexible member wraps at least a part of the brush plate to effectively prevent the brush plate from directly and rigidly contacting the tooth surface, the gum, the oral cavity inner skin and other soft parts when the amplitude of vibration of the electric toothbrush head is large, thereby improving the comfort of use.

In some embodiments, the flexible member includes the first flexible portion and the second flexible portion, and a thickness of the second flexible portion is smaller than a thickness of the first flexible portion; and/or the flexible member includes the first flexible portion and the third flexible portion, and a thickness of the third flexible portion is smaller than the thickness of the first flexible portion.

In some embodiments, a thickness of the first flexible portion is greater than ½ of a thickness of the brush plate.

In some embodiments, the flexible member includes the first flexible portion and the second flexible portion. The first flexible portion is configured to extend towards a peripheral side surface of the brush plate and be connected to the second flexible portion; and/or the flexible member includes the third flexible portion and the second flexible portion, and the third flexible portion is configured to extend towards the peripheral side surface of the brush plate and be connected to the second flexible portion.

In some embodiments, the flexible member includes the first flexible portion, the second flexible portion, and the third flexible portion, and the flexible member is configured to wrap the brush plate.

In some embodiments, the flexible member includes the first flexible portion. The brush rod includes a groove portion formed on a back surface of the brush rod. The flexible member further includes an extension portion filled in the groove portion and connected to the first flexible portion. The groove portion includes at least one flared section having a width increasing in a direction from the brush plate to the brush rod to prevent separation of the extension portion from the brush rod when the brush plate is elastically deformed.

In some embodiments, a width of the groove portion is decreased first and then increased in the direction from the brush plate to the brush rod.

In some embodiments, the brush plate is a resilient brush plate that is bendable and twistable.

In some embodiments, a thickness of at least a part of the brush rod is greater than a maximum thickness of the brush plate.

In some embodiments, a cross-sectional area of an end of the brush plate connected to the brush rod is smaller than a cross-sectional area of the first end of the brush rod to allow for a cross-sectional abrupt change at a junction of the brush plate and the brush rod.

In some embodiments, the flexible member is partially arranged at the junction of the brush plate and the brush rod to smoothen an outer surface of the electric toothbrush head at the junction of the brush plate and the brush rod.

In some embodiments, the brush plate and the brush rod are integrally molded as one piece, and/or the brush plate is made of polystyrene.

In some embodiments, the brush plate and the brush rod are respectively molded. The brush head body further includes a connecting portion configured for connection of the brush plate and the brush rod. In other words, the brush plate and the brush rod are connected through the connecting portion.

In some embodiments, the connecting portion is arranged on the back surface of the brush plate. The connecting portion and the brush rod are integrally molded as one piece. The flexible member is partially arranged between the connecting portion and the brush plate and is configured to connect the connecting portion and the brush plate.

In some embodiments, the connecting portion is arranged between the brush plate and the brush rod and is configured to connect the brush plate and the brush rod in the longitudinal direction of the brush rod. An elastic deformability of the connecting portion is greater than an elastic deformability of any one of the brush plate and the brush rod.

In some embodiments, the brush plate has a plurality of mounting holes formed therein, and each of the plurality of mounting holes is configured to accommodate the root portion of respective bristles.

In some embodiments, the brush plate includes a plurality of annular protrusions formed on the front surface of the brush plate. The plurality of mounting holes are arranged inside the plurality of annular protrusions, respectively. The flexible member includes the third flexible portion. The third flexible portion includes a plurality of avoidance holes formed in the third flexible portion. The plurality of avoidance holes are configured to allow the plurality of annular protrusions to pass through the plurality of avoidance holes. A thickness of the third flexible portion is equal to or smaller than a height of each of the plurality of annular protrusions.

In some embodiments, the height of each of the plurality of annular protrusions is equal to or smaller than 2 mm; and/or the plurality of annular protrusions are soft.

In some embodiments, the mounting holes are through holes. The root portion of each of the plurality of bristles is connected to one of the plurality of mounting holes through holt melting. The flexible member includes the first flexible portion, and the first flexible portion is configured to cover the plurality of mounting holes.

In some embodiments, the plurality of bristles include a hot melt connection pad formed on the back surface of the brush plate. The hot melt connection pad is configured to extend to a peripheral region of the plurality of mounting holes and be covered by the first flexible portion.

In some embodiments, the brush plate includes an annular rib formed on the back surface of the brush plate. The annular rib is configured to extend along an edge of the brush plate to form an inner region. The hot melt connection pad is located in the inner region of the annular rib. A thickness of the hot melt connection pad is smaller than or equal to a height of the annular rib. The first flexible portion is configured to cover the inner region of the annular rib and extend out of the inner region of the annular rib.

In some embodiments, the brush plate has a pre-melted state and a post-melted state. In the pre-melted state, the back surface of the brush plate includes a hot melting structure around each of the plurality of mounting holes, and the hot melting structure includes a hot melting post. In the post-melted state, the hot melted connection pad and the hot melting structure are fused together as one piece.

In some embodiments, at least one of the mounting holes includes a mounting tube provided in the at least one of the mounting holes. The mounting tube is configured to accommodate the root portion of each of the bristles inside the mounting tube. The mounting tube is an elastic tube and is elastically deformable synchronously with the brush plate.

An electric toothbrush according to an embodiment of a second aspect of the present disclosure includes: a brush handle and a brush head assembly, wherein the brush head assembly is the electric toothbrush head according to any one of the above-mentioned embodiments. Therefore, an overall performance of the electric toothbrush can be improved by the provision of the electric toothbrush head.

Additional aspects and advantages of the present disclosure will be given in part in the following descriptions, such that the present disclosure becomes apparent and understandable to those skilled in the art.

### BRIEF DESCRIPTION OF DRAWINGS

The above-mentioned and/or additional aspects and advantages of the present disclosure will become apparent and more readily appreciated from the following descriptions with reference to the accompanying drawings, in which:

FIG. 1 is a schematic perspective view of an electric toothbrush head according to a first embodiment of the present disclosure;

FIG. 2 is a top view of the electric toothbrush head according to the first embodiment of the present disclosure;

FIG. 3 is a front view of the electric toothbrush head according to the first embodiment of the present disclosure;

FIG. 4 is a cross-sectional schematic view of the electric toothbrush head according to the first embodiment of the present disclosure when observed from an angle;

FIG. 5 is a cross-sectional schematic view of the electric toothbrush head according to the first embodiment of the present disclosure when observed from another angle;

FIG. 6 is a schematic perspective view of a brush head body of the electric toothbrush head according to the first embodiment of the present disclosure;

FIG. 7 is a top view of the electric toothbrush head according to the first embodiment of the present disclosure;

FIG. 8 is a schematic view of bristles of an electric toothbrush head according to an embodiment of the present disclosure;

FIG. 9 is a schematic perspective view of a flexible member of the electric toothbrush head according to the first embodiment of the present disclosure;

FIG. 10 is a schematic perspective view of an electric toothbrush head according to a second embodiment of the present disclosure;

FIG. 11 is a top view of the electric toothbrush head according to the second embodiment of the present disclosure;

FIG. 12 is a front view of the electric toothbrush head according to the second embodiment of the present disclosure;

FIG. 13 is a cross-sectional schematic view of the electric toothbrush head according to the second embodiment of the present disclosure when observed from an angle;

FIG. 14 is a schematic view of coordination between bristles and a flexible member of the electric toothbrush head according to the second embodiment of the present disclosure;

FIG. 15 is a schematic perspective view of an electric toothbrush head according to a third embodiment of the present disclosure;

FIG. 16 is a cross-sectional schematic view of the electric toothbrush head according to the third embodiment of the present disclosure when observed from an angle;

FIG. 17 is a schematic view of a brush head body of the electric toothbrush head according to the third embodiment of the present disclosure;

FIG. 18 is a schematic view of a flexible member of the electric toothbrush head according to the third embodiment of the present disclosure;

FIG. 19 is a schematic structural diagram of an electric toothbrush applied with an electric toothbrush head according to a fourth embodiment of the present disclosure;

FIG. 20 is a schematic perspective view of the electric toothbrush head according to the fourth embodiment of the present disclosure;

FIG. 21 is a schematic exploded view of the electric toothbrush head according to the fourth embodiment of the present disclosure from a viewing angle;

FIG. 22 is a schematic exploded view of the electric toothbrush head according to the fourth embodiment of the present disclosure from another viewing angle;

FIG. 23 is a schematic structural diagram of the electric toothbrush head according to the fourth embodiment of the present disclosure; and

FIG. 24 is a schematic structural sectional view taken along A-A in FIG. 23.

### REFERENCE NUMERALS

electric toothbrush 1000, brush handle 200, electric toothbrush head 100,

brush head body 10, brush rod 11, first end 11a, second end 11b, groove portion 111, brush plate 12, front surface 12a, back surface 12b, annular rib 121, hot melting structure 122, annular protrusion 125, connecting soft rubber 120, first connecting surface 1210, first connecting groove 1211, second connecting surface 1220, brush rod 13, first connecting segment 131, second connecting segment 132, connecting end surface 133, fixing ring 15, bristle planting opening 151, first direction A1, second direction A2, third direction B,

bristle 20, root portion 21, head portion 22, bristle bundle 201,

flexible member 30, first flexible portion 31, extension portion 32, second flexible portion 33, third flexible portion 34,

connecting portion 40, mounting tube 50, avoidance hole a, mounting hole b.

### DESCRIPTION OF EMBODIMENTS

Hereinafter, embodiments of the present disclosure will be described in detail, and examples of the embodiments are illustrated in the accompanying drawings, throughout which same or similar reference numerals refer to the same or similar elements or elements having the same or similar functions. The embodiments described below with reference to the accompanying drawings are illustrative and are only for the purpose of explaining the present disclosure and are not to be construed as limiting the present disclosure.

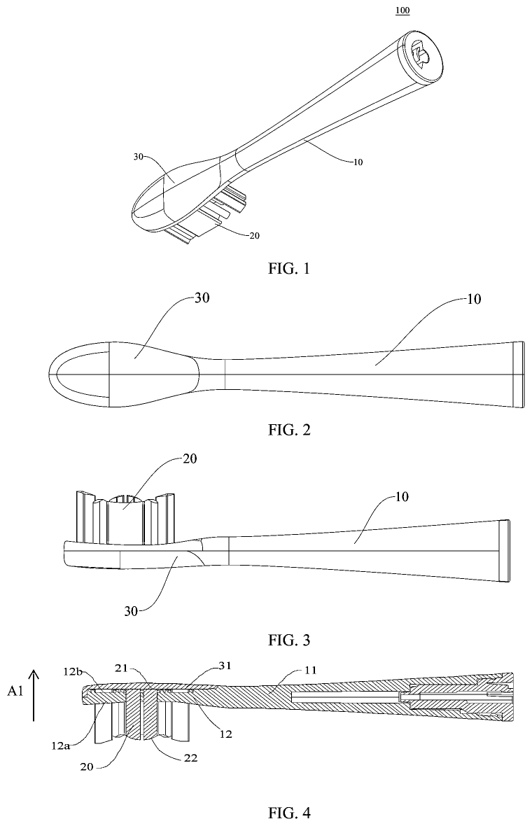

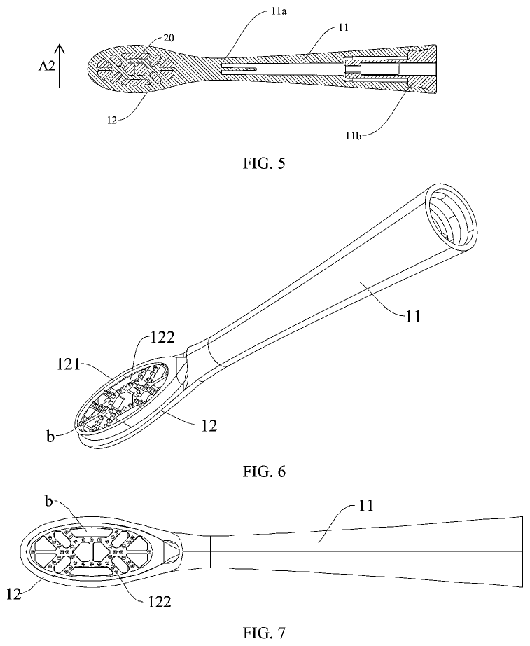

Referring now to FIGS. 1 to 18, electric toothbrush heads 100 according to embodiments of the present disclosure are described. It is noted that a direction indicated by an arrow A1 in FIG. 4 is a first direction, and a direction indicated by an arrow A2 in FIG. 5 is a second direction, and a direction indicated by an arrow B in FIG. 20 is a third direction.

As shown in FIGS. 1 to 3, an electric toothbrush head 100 according to an embodiment of the present disclosure includes: a brush head body 10, bristles 20, and a flexible member 30. As shown in FIGS. 4 to 6, the brush head body 10 includes a brush rod 11 and a brush plate 12. The brush rod 11 includes a first end 11a and a second end 11b that are opposite to each other in a longitudinal direction (i.e., the third direction) of the brush rod 11. The brush plate 12 is connected to the first end 11a of the brush rod 11. The brush plate 12 includes a front surface 12a and a back surface 12b in a thickness direction (i.e., the first direction) of the brush plate 12. The brush plate 12 is elastically deformable and has a non-deformed state and an elastically deformed state relative to the brush rod 11. A maximum deformable angle of the brush plate 12 relative to the brush rod 11 is equal to or greater than 10 degrees, and the elastically deformed state includes a first deformed state in which the brush plate 12 is bendable or deformable towards the front surface 12a relative to the brush rod 11, and a second deformed state in which the brush plate 12 is bendable or deformable towards the back surface 12b relative to the brush rod 11.

It should be noted that the maximum deformable angle of the brush plate 12 relative to the brush rod 11 is equal to or greater than 10 degrees, which means that one end of the brush plate 12 is a fixed end connected to the first end 11a of the brush rod 11, and the other end of the brush plate 12 is a free end. A connection line between the fixed end and the free end of the brush plate 12 is an initial connection line when the brush plate 12 is in the non-deformed state relative to the brush rod 11. The connection line between the fixed end and the free end of the brush plate 12 is an instant connection line when the brush plate 12 is in the elastically deformed state relative to the brush rod 11. When the brush plate 12 is elastically deformed relative to the brush rod 11, an included angle between the instant connection line and the initial connection line is changeable within a range from 0 degrees to X degrees (i.e., 0 degrees≤the included angle≤X degrees). Where the X degrees are equal to or greater than 10 degrees, for example, X degrees may be 10 degrees, 12 degrees, 14 degrees, 16 degrees, 18 degrees, 20 degrees, 22 degrees, 24 degrees, 26 degrees, 28 degrees, 30 degrees, 32 degrees, 34 degrees, 36 degrees, 38 degrees, 40 degrees, 42 degrees, 44 degrees, 45 degrees, etc.

With reference to FIGS. 1 and 5, the second end 11b of the brush rod 11 is adapted to be connected to a brush handle of the electric toothbrush. Vibration generated at the brush handle of the electric toothbrush is transmitted to the brush plate 12 by the brush rod 11. The brush plate 12 is elastically deformable and has the non-deformed state and the elastically deformed state relative to the brush rod 11, and the maximum deformable angle of the brush plate 12 relative to the brush rod 11 is equal to or greater than 10 degrees. As a result, the brush plate 12 is elastic and deformable enough to generate a flexible vibration effect when vibrating, and thus, the brush plate 12 vibrates with a larger amplitude, so that the cleaning effect is improved without increasing amplitude of a motor, thereby effectively avoiding hand vibration caused by using a motor with a large amplitude. Therefore, a better cleaning effect and a comfortable handheld experience can be realized at the same time.

Moreover, the brush plate 12 is elastically deformable and has the non-deformed state and the elastically deformed state relative to the brush rod 11, and the maximum deformable angle of the brush plate 12 relative to the brush rod 11 is equal to or greater than 10 degrees, so that when a reaction force exerted on the bristles 20 by the teeth reaches a threshold value, the brush plate 12 can be elastically deformed to buffer the pressure exerted on the bristles 20, and the pressure exerted on tooth surfaces and gums by the brush plate 12 through the bristles 20 is reduced, thereby relatively softening a force applied by the bristles 20.

In addition, since the brush plate 12 is elastically deformable and has the non-deformed state and the elastically deformed state relative to the brush rod 11, and the maximum deformable angle of the brush plate 12 relative to the brush rod 11 is equal to or greater than 10 degrees, the brush plate 12 can fit the teeth in different regions of a same user more effectively, and the brush plate is better adapted to tooth surface shapes of the teeth of different users, so as to improve the cleaning effect.

It should be noted that the brush plate 12 is bendable or deformable towards the front surface 12a relative to the brush rod 11 in the first deformed state and the brush plate 12 is bendable or deformable towards the back surface 12b relative to the brush rod 11 in the second deformed state, which means that the brush plate 12 can be bendable or deformable in any direction towards the front surface 12a relative to the brush rod 11 in the first deformed state, for example, the brush plate 12 includes a first left side, a first middle portion and a first right side in the front surface 12a along a width direction (i.e., second direction) of the brush plate 12. The brush plate 12 may be bent towards the first left side of the brush plate 12, towards the first right side of the brush plate 12, or towards the first middle portion of the brush plate 12, or the like. The brush plate 12 can be bendable or deformable in any direction towards the back surface 12b relative to the brush rod 11 in the second deformed state, for example, the brush plate 12 includes a second left side, a second middle portion and a second right side in the back surface 12b along the width direction of the brush plate 12. The brush plate 12 may be bent towards the second left side of the brush plate 12, towards the second right side of the brush plate 12, or towards the second middle portion of the brush plate 12, or the like, thereby being better adapted to different mouth shapes and different positions in the mouth and achieving both comfort of use and thorough cleaning.

As shown in FIG. 8, a root portion 21 and a head portion 22 are respectively provided at two ends of each bristle 20 in a longitudinal direction of the bristle 20. The root portion 21 of the bristle 20 is directly or indirectly connected to the brush plate 12. For example, the root portion 21 is directly connected to the brush plate 12 by an adhesive fixation, a heat fusion fixation, etc. The root portion 21 is indirectly connected to the brush plate 12 by fixing the bristle 20 to a support which is fixed to the brush plate 12, etc. The head portion 22 of the bristle 20 is configured to extend out from the front surface 12a of the brush plate 12, and may be configured to extend outwards perpendicularly or obliquely. The wording “obliquely” refers that the longitudinal direction of the bristle 20 is not parallel to a normal of the brush plate 12.

As shown in FIGS. 1 and 4, a hardness of the flexible member 30 is smaller than a hardness of the brush plate 12. The flexible member 30 includes at least one of a first flexible portion 31, a second flexible portion 33, or a third flexible portion 34. The first flexible portion 31 is arranged on the back surface 12b of the brush plate 12. The second flexible portion 33 is arranged on a peripheral side of the brush plate 12. The third flexible portion 34 is arranged on the front surface 12a of the brush plate 12. In such a manner, the flexible member 30 can wrap at least a part of the brush plate 12 to soften contact between the brush plate 12 and the oral cavity surface, or the gum surface, or the tooth surface due to relative softness of the flexible member 30, thereby improving comfort of use. Moreover, the brush plate 12 is relatively hard, so that it is easier to secure the bristles 20 to the brush plate 12 and the connection of the bristles 20 and the brush plate 12 is more reliable. Furthermore, the elastic deformation of the brush plate 12 is not negatively affected by the flexible member 30 since the flexible member 30 is relatively softer, ensuring that the brush plate 12 can be elastically deformed effectively.

As shown in FIGS. 1, 4 and 9, the flexible member 30 includes at least the first flexible portion 31 being located on a side of the root portion 21 of the bristle 20 away from the head portion 22 and being configured to cover at least a part of the back surface 12b of the brush plate 12. Therefore, the first flexible portion 31 can cover at least the part of the back surface 12b of the brush plate 12 while shielding the back surface 12b of the bristles 20, thereby protecting the bristles 20 and rendering the connection between the bristles 20 and the brush plate 12 more reliable. In addition, the first flexible portion 31 can act as a flexible layer to reduce a collision of the back surface 12b of the brush plate 12 with the oral cavity, thereby further improving the user comfort. Furthermore, since the amplitude of vibration of the brush plate 12 according to the embodiment of the present disclosure is relatively large, the arrangement of the first flexible portion 31 can provide flexible protection more effectively on the surface of the oral cavity when the bristles 20 are subjected to a reaction force from the tooth surface and has a relative great elastic deformation in an opposite direction.

As shown in FIGS. 1 and 9, the flexible member 30 includes at least the second flexible portion 33 being configured to cover at least a part of the peripheral side of the brush plate 12 to solve at least the following troubles. For example, when the user uses the electric toothbrush and turns the brush plate 12 from outer tooth surfaces to inner tooth surfaces or from inner tooth surfaces to outer tooth surfaces, the movement of the brush plate 12 in the oral cavity will cause collision between the peripheral side of the brush plate 12 and the teeth. For example, when the bristles 20 clean the tooth surfaces, the vibration of the brush plate 12 in the width direction thereof is likely to cause the peripheral side of the brush plate 12 to give an impact on the oral cavity surface. And further, for example, when a longitudinal axis of the brush plate 12 is inclined with respect to a center of each tooth surface, the peripheral side of the brush plate 12 is also likely to give an impact on the oral cavity surface. Because at least the part of the peripheral side of the brush plate 12 is wrapped by the relatively soft second flexible portion 33, the rigid contact between the peripheral side surface of the brush plate 12 and the oral cavity surface, the gum surface, the tooth surface, or the like can be minimized, and the use comfort can be improved.

As shown in FIGS. 12 to 14, the flexible member 30 includes at least the third flexible portion 34 being configured to cover at least a part of the front surface 12a of the brush plate 12. The third flexible portion 34 includes a plurality of avoidance holes a formed in the third flexible portion 34 to allow a portion of the bristle 20 located on the front surface 12a of the brush plate 12 to pass through the avoidance hole a. In the case that the user applies a large force to the electric toothbrush during brushing, the brush plate 12 is pressed towards the tooth surface, and the bristles 20 may be deformed to a large extent when contacting the tooth surface, and therefore, the front surface 12a of the brush plate 12 may contact the tooth surface or the gum. Considering the aforementioned troubles, the third flexible portion 34 that is relatively soft is provided to cover at least the part of the front surface 12a of the brush plate 12, so as to, as much as possible, get rid of the rigid contact between the front surface 12a of the brush plate 12 and the gum surface, the tooth surface, or the like, thereby improving the use comfort.

The first flexible portion 31, the second flexible portion 33, and the third flexible portion 34 may be made of the same material, for example, be made of the same soft materials, such as silica gel, rubber.

In some embodiments, as shown in FIGS. 1 and 9, the flexible member 30 includes the first flexible portion 31 and the second flexible portion 33, so as to form a better flexible barrier at the back surface 12b and the peripheral side of the brush plate 12, and to form a better and more comprehensive protection for the oral cavity, the gum surface, and the like.

Alternatively, when the flexible member 30 includes both the first flexible portion 31 and the second flexible portion 33, a thickness of the second flexible portion 33 is smaller than that of the first flexible portion 31. Thereby, peripheral side edges of the flexible member 30 can be narrowed to free up more space for the arrangement of the brush plate 12, and consequently, there is an enlarged area on the brush plate 12 for the arrangement of the bristles 20.

Illustratively, the thickness of the second flexible portion 33 is equal to or smaller than 1 mm, which can stop the second flexible portion 33 from taking up too much area, so as not to affect the distribution of the bristles 20.

Alternatively, when the flexible member 30 includes both the first flexible portion 31 and the second flexible portion 33, the first flexible portion 31 extends towards surfaces of the peripheral side of the brush plate 12 to get connected to the second flexible portion 33. It is understood that the first flexible portion 31 extends along the length and width directions of the back surface 12b of the brush plate 12, and the second flexible portion 33 is arranged around peripheral edges of the first flexible portion 31 and extends along the thickness direction of the brush plate 12. The first flexible portion 31 and the second flexible portion 33 can cover the back surface 12b and at least a part of the peripheral side of the brush plate 12 when the first flexible portion 31 and the second flexible portion 33 are connected.

Therefore, on one hand, the connection of the flexible member 30 and the brush plate 12 becomes more stable, and partial warpage of the flexible member 30 can be reduced. On the other hand, the flexible member 30 is able to cover more parts of the brush plate 12, so that a rigid portion of the brush plate 12, including a rigid edge where the back surface 12b meets a peripheral surface of the brush plate 12, can be better isolated from the gum, the oral cavity, the tooth surface, and the like, thereby further improving the comfort of use.

In some embodiments, as shown in FIGS. 12 and 14, the flexible member 30 includes both the second flexible portion 33 and the third flexible portion 34, so as to form a better flexible barrier at the front surface 12a and the peripheral side of the brush plate 12, and to form a better and more comprehensive protection for the oral cavity, the gum, the tooth surface, and the like.

Alternatively, when the flexible member 30 includes both the second flexible portion 33 and the third flexible portion 34, the third flexible portion 34 is configured to extend towards the surfaces of the peripheral side of the brush plate 12 to get connected to the second flexible portion 33. Therefore, on one hand, the connection of the flexible member 30 and the brush plate 12 becomes more stable, and the partial warpage of the flexible member 30 can be reduced. On the other hand, the flexible member 30 is able to cover more parts of the brush plate 12, and can better isolate the rigid portion of the brush plate 12, including a rigid portion where the front surface 12a and the peripheral surface of the brush plate 12 meet, from the gum, the oral cavity, the tooth surface, and the like, to further improve the comfort of use.

In some embodiments, as shown in FIGS. 12 and 14, the flexible member 30 includes both the first flexible portion 31 and the third flexible portion 34, so as to form a better flexible barrier at the front surface 12a and the back surface 12b of the brush plate 12, and provide a better and more comprehensive protection for the oral cavity, the gum, the tooth surface, etc.

Alternatively, a thickness of the third flexible portion 34 is smaller than a thickness of the first flexible portion 31. Specifically, a combination of the brush plate 12 and the flexible member 30 is required to be adequately thick to ensure an overall strength of the electric toothbrush head 100. And in order to ensure that the brush plate 12 has better elasticity, the thickness of the brush plate 12 cannot be too thick. Therefore, the flexible member 30 should be adequately thick to compensate the thinness of the brush plate 12. If the third flexible portion 34 on the front surface 12a is too thick and is formed by injection molding, it is hard to perform the injection molding uniformly due to the influence from the bristles 20 during the injection molding, and thus the uniformity of the overall elasticity is influenced. Therefore, the first flexible portion 31 on the back surface 12b is arranged to be relatively thicker to compensate the thinness of the brush plate 12 and the third flexible portion 34 and to form better buffer protection at the back surface 12b of the brush plate 12.

Exemplarily, the thickness of the third flexible portion 34 does not exceed 1 mm. If the thickness of the third flexible portion 34 is too large, the soft rubber has poor fluidity during injection, which causes uneven injection molding structure and influences the electric toothbrush head 100 to have uniform elasticity in the whole.

Alternatively, the thickness of the first flexible portion 31 is greater than ½ of the thickness of the brush plate 12. In other words, the thickness of the first flexible portion 31 is half or more than half of the thickness of the brush plate 12. Therefore, on one hand, the thickness of the brush plate 12 can be kept relatively small to ensure the elasticity of the brush plate 12. On the other hand, the first flexible portion 31 at the back surface 12b can be used for effective elastic compensation and can be stably connected to the back surface 12b of the brush plate 12, so as to improve the overall structural strength of the electric toothbrush head 100.

In some embodiments, as shown in FIGS. 12 and 14, the flexible member 30 includes all of the first flexible portion 31, the second flexible portion 33, and the third flexible portion 34, so as to form a better flexible barrier at the front surface 12a, the back surface 12b and the peripheral side of the brush plate 12, and to form a better and more comprehensive protection for the oral cavity, the gum, the tooth surface, etc.

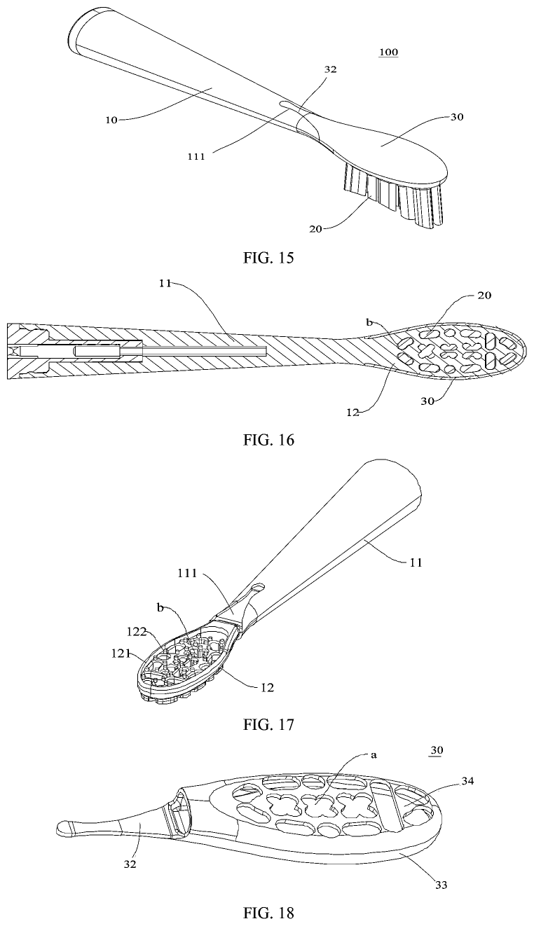

Alternatively, as shown in FIG. 15, when the flexible member 30 includes all of the first flexible portion 31, the second flexible portion 33, and the third flexible portion 34, the flexible member 30 may be further configured to wrap entire surfaces of the brush plate 12. That is, outer surfaces of the brush plate 12 are covered by the flexible member 30. The flexible member 30 is configured as a flexible sleeve having a profile substantially identical to that of the brush plate 12, and is injection-molded or sleeved on the brush plate 12. A portion of the flexible member 30 on the front surface 12a of the brush plate 12 includes avoidance holes a being used for the bristles 20 to pass therethrough.

Therefore, on one hand, the connection between the flexible member 30 and the brush plate 12 can be more stable and more reliable, and the partial warpage of the flexible member 30 can be further reduced. On the other hand, the flexible member 30 covers more parts of the brush plate 12, and can better isolate the rigid portion of the brush plate 12, including the rigid portions such as junctions of the back surface, the peripheral surface, the front surface and adjacent surfaces, from the gum, the oral cavity, the tooth surface, and the like, so as to further improve the comfort of use.

In some embodiments, when the flexible member 30 includes at least the first flexible portion 31, as shown in FIGS. 15 to 18, the brush rod 11 includes a groove portion 111 formed on a back surface of the brush rod 11. The flexible member 30 further includes an extension portion 32. The extension portion 32 is filled in the groove portion 111 and is connected to the first flexible portion 31. The groove portion 111 includes at least one flared section having a width increasing in a direction from the brush plate 12 to the brush rod 11 to prevent separation of the extension portion 32 from the brush rod 11 when the brush plate 12 is elastically deformed.

In other words, the back surface of the brush rod 11 and the back surface 12b of the brush plate 12 are on the same side. The groove portion 111 is arranged at the first end 11a of the brush rod 11. The extension portion 32 matches with the groove portion 111. The groove portion 111 can include at least one flared section (i.e., the width of the groove portion 111 gradually increases along the direction from the brush plate 12 to the brush rod 11). The flexible member 30 includes the extension portion 32 provided on a side thereof facing the first end 11a of the brush rod 11. The extension portion 32 is configured to be connected to the brush rod 11, and the extension portion 32 is shaped to match with a shape of the groove portion 111 and is filled in the groove portion 111.

In this way, the extension portion 32 and the first flexible portion 31 can jointly buffer the reaction force of the tooth surface on the back surface 12b of the brush plate 12 and effectively protect the gum and an inner surface of the oral cavity. At the same time, when the brush plate 12 is deformed, the extension portion 32 is limited by the flared section, which can effectively prevent the extension portion 32 from detaching from the groove portion 111. Therefore, the cooperation of the flexible member 30 and the brush head body 10 is more stable, and the service life of the electric toothbrush head 100 is prolonged.

Further, in an embodiment, the extension portion 32 is inserted in the groove portion 111 in interference fit, so as to better prevent the extension portion 32 from detaching from the groove portion 111, improve the stability of the cooperation of the flexible member 30 and the brush head body 10, and prolong the service life of the electric toothbrush head 100. Alternatively, the extension portion 32 may be injection molded in the groove portion 111, thereby simplifying the process and further improving the connection reliability.

In some alternative embodiments, the first flexible portion 31 and the extension portion 32 may be integrally molded as one piece, or, in other embodiments, the first flexible portion 31 and the extension portion 32 may be respectively molded. The first flexible portion 31 may be fixed to the back surface 12b of the brush plate 12, and the extension portion 32 is fixed partially to the back surface 12b of the brush plate 12 and partially within the groove portion 111, or the extension portion 32 is completely fixed within the groove portion 111, etc.

In addition, in some embodiments, the flexible member 30 can be an integral injection molding member as a whole, and is connected to the brush head body 10 by injection molding, so as to simplify the processing and improve the reliability of the combination of the flexible member 30 and the brush head body 10.

In some embodiments, a groove wall of the groove portion 111 may be configured as a curved wall, thereby facilitating the flow of an injection molding material within the groove portion 111 and improving the uniformity of injection molding.

Alternatively, the width of the groove portion 111 first decreases and then increases in a direction from the brush plate 12 to the brush rod 11. Accordingly, the groove portion can be formed in a form whose opening first contracts and then expands, which can narrow a wider part and broaden a narrow part, so as to ensure that the width of the groove portion 111 can be relatively uniform as a whole. Therefore, the connection between the extension portion 32 and the groove portion 111 is more reliable with better anti-detachment property, and the relatively uniform width of the groove portion 111 is more favorable to the injection molding.

In some embodiments, the brush plate 12 is formed as a resilient brush plate that is bendable and twistable. That is, a connecting line between the free end and the fixed end of the brush plate 12 can be bent, deflected, twisted, etc., so that the brush plate can be better suitable for different tooth surface shapes, and thus the fitting and cleaning effect can be improved. The orientation of brushing surfaces of the bristles 20 is variable by twisting the brush plate 12. When teeth are brushed by a scientific brushing method (Bass brushing method), the teeth can be better brushed by twisting the brush plate 12, and the twist angle of the wrist can be reduced.

In some embodiments, as shown in FIGS. 3 and 4, a thickness of at least a part of the brush rod 11 is greater than a maximum thickness of the brush plate 12. This is advantageous to the elastic deformation of the brush plate 12 relative to the brush rod 11. For example, a cross-sectional area of the brush rod 11 gradually decreases towards the brush plate 12, so that the relatively smaller thickness of the brush plate 12 compared with the brush rod 11 can ensure the elasticity of the brush plate 12, and during the tooth brushing, the brush rod 11 has smaller deformation amplitude when being applied with a force, such that the vibration of the motor can be more efficiently transmitted to the brush plate 12.

Alternatively, when a smallest thickness of the brush rod 11 is also greater than the thickness of the brush plate 12, the brush plate 12 can better exert elastic deformation, and the problem of the brush rod 11 vibrating the hand is better avoided.

Alternatively, a cross-sectional area of the fixed end of the brush plate 12 is smaller than a cross-sectional area of the first end of the brush rod 11, so that the brush head body 10 has a position with a cross-sectional abrupt change between the brush plate 12 and the brush rod 11, that is, the brush plate 12 has a cross-sectional abrupt change configured at least in a region thereof connected to the brush rod 11, so that the position with the cross-sectional abrupt change is formed as an elastic connection region, and through elastic deformation of the position with the cross-sectional abrupt change, a maximum deformable angle of the brush plate 12 relative to the brush rod 11 is equal to or greater than 10 degrees, which effectively improves the cleaning effect of the electric toothbrush head 100.

As shown in FIGS. 10 to 13, in some embodiments, the flexible member 30 is partially arranged at the position with the cross-sectional abrupt change to make the outer surface of electric toothbrush head 100 at a junction of the brush plate 12 and the brush rod 11 smooth. Thus, on the one hand, an appearance of the electric toothbrush head 100 is smoother to improve the holding comfort and avoid the accumulation of dirt in the position with the cross-sectional abrupt change, so as to realize better cleaning performance; and on the other hand, the connection between the brush plate 12 and the brush rod 11 is more stable.

In some embodiments, as shown in FIG. 4, the brush plate 12 and the brush rod 11 are integrally molded as one piece. In this way, the processing of the electric toothbrush head 100 is simpler and more convenient, which can improve machining efficiency and reduce the processing cost. The brush plate 12 can be made of thermoplastic elastomer materials, which can improve the elasticity of the brush plate 12.

In some embodiments, the brush rod 11 is made of polystyrene (TPE material, a thermoplastic elastomer). For example, when the brush rod 11 and the brush plate 12 are configured as an integrally molded piece, the brush rod 11 and the brush plate 12 may be configured as an integrally molded piece processed by polystyrene; and when the brush plate 12 and the brush rod 11 are respectively molded, at least the brush plate 12 is made of polystyrene. This ensures that the brush plate 12 has a good elastic deformability.

In some embodiments, such as shown in FIGS. 12 and 13, the brush plate 12 and the brush rod 11 are respectively molded. The brush head body 10 further includes a connecting portion 40 configured to connect the brush plate 12 and the brush rod 11.

In other words, in the embodiments where the brush plate 12 is separated from the brush rod 11, the brush rod 11 is arranged on the connecting portion 40, and the connecting portion 40 is connected to the brush rod 11. The connecting portion 40 can have elasticity to improve the elasticity of the brush plate 12. The brush plate 12 is used for the bristles 20 to be installed on the brush plate 12, and the separate arrangement of the brush plate 12 and the brush rod 11 facilitates the installation of the bristles 20 on the brush plate 12, and improves the assembling convenience of the electric toothbrush head 100.

In some embodiments, referring to FIG. 13, the connecting portion 40 is arranged on the back surface 12b of the brush plate 12, the connecting portion 40 and the brush rod 11 are integrally molded as one piece, and the flexible member 30 is partially arranged between the connecting portion 40 and the brush plate 12 to connect the connecting portion 40 and the brush plate 12.

Therefore, the connecting portion 40 is formed as a bracket connected to the first end 11a of the brush rod 11, for example, the bracket can be elastic to support the brush plate 12 and elastically deform synchronously with the brush plate 12. The brush plate 12 is connected to the connecting portion 40 through the flexible member 30, and the flexible member 30 at least partially covers the connecting portion 40 to enlarge a bonding area of the connecting portion 40 and the flexible member 30, so as to improve the stability of the connection of the brush plate 12 and the connecting portion 40, thereby effectively compensating the elasticity of the brush plate 12.

In the embodiments where the brush rod 11 and the brush plate 12 are connected by the connecting portion 40, optionally, the connecting portion 40 is elongated along the longitudinal direction of the brush rod 11 and is arranged between the brush rod 11 and the brush plate 12, and the elastic deformability of the connecting portion 40 is stronger than that of any one of the brush rod 11 and the brush plate 12.

In this way, during the tooth brushing, the connecting portion 40 is elastically deformed and drives the brush plate 12 to move with a greater amplitude relative to the brush rod 11. During the vibration of the connecting portion 40 and the brush plate 12, the brush rod 11 hardly moves, so as to improve the cleaning effect. In addition, the connecting portion 40 is covered by the flexible member 30, which prevents the connecting portion 40 from causing damage to the gum.

The present disclosure is not limited thereto, for example, in other embodiments, the connecting portion 40 and the brush rod 11 are respectively molded; and the connecting portion 40 and the brush rod 11 are connected by assembling, or fixedly connected by other manners, such as adhesion. Other connection manners are not described herein in detail.

As shown in FIGS. 4 to 7, according to some embodiments of the present disclosure, the brush plate 12 includes mounting holes b formed thereon, and root portions 21 of the bristles 20 are arranged in the mounting holes b, so that the root portions 21 of the bristles 20 can be limited by the mounting holes b to better stabilize the connection of the bristles 20 and better clean the tooth surface by the bristles 20. For example, the bristles 20 can be grouped into several bristle bundles. Geometric shapes of the bristle bundles are the same or different. Each mounting hole b is provided with one bristle bundle.

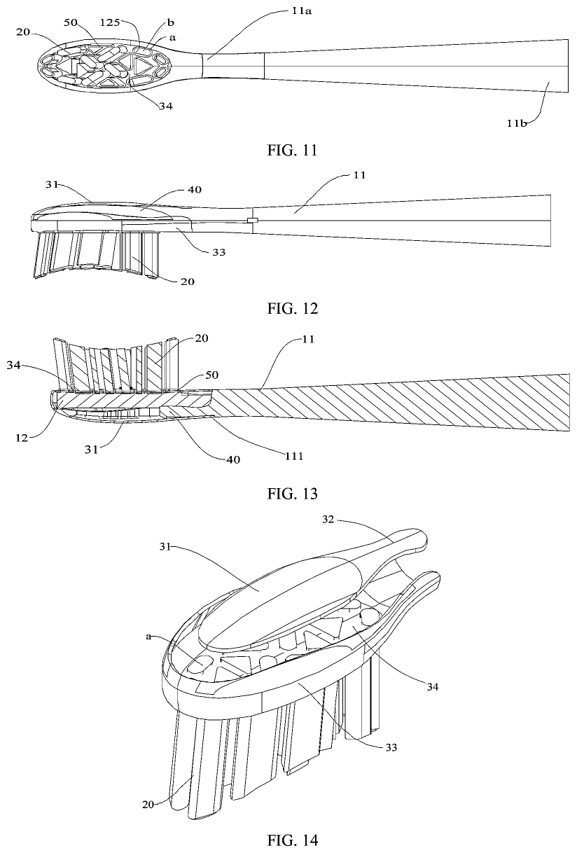

Alternatively, as shown in FIGS. 10 and 11, the brush plate 12 includes a plurality of annular protrusions 125 formed on the front surface 12a thereof. The mounting holes b are respectively arranged inside the annular protrusions 125. In some embodiments, an interior of each of the plurality of annular protrusions 125 is hollow to form a mounting hole b. The flexible member 30 includes the third flexible portion 34, and the third flexible portion 34 includes avoidance holes a formed thereon for the plurality of annular protrusions to pass through the avoidance holes a. A thickness of the third flexible portion 34 is equal to or smaller than a height of each of the plurality of annular protrusions 125. Accordingly, when the third flexible portion 34 is processed through an injection molding process to rest on the brush plate 12, the presence of the annular protrusions 125 can prevent materials in a fluid state from flowing into the mounting holes b of the bristles 20 during the injection molding process, so as to avoid the phenomenon of bristle adhesion, thereby facilitating subsequent cleaning of the electric toothbrush head 100 and avoiding the accumulation of dirt between the bristles 20.

Alternatively, the height of each of the plurality of annular protrusions 125 is equal to or smaller than 2 mm. Therefore, the annular protrusions 125 less limits the deformation of the bristles 20, and the bristles 20 can better exert deformation to improve the cleaning effect of tooth surface.

Alternatively, the annular protrusions 125 are soft, i.e., has some flexibility, which can reduce the restriction of the annular protrusions 125 to the deformation of the bristles 20. Therefore, the bristles 20 can better exert deformation to increase tooth surface cleanliness.

In some embodiments, the mounting holes b are through holes. The root portions 21 of the bristles 20 are connected to the mounting holes b through holt melting. The flexible member 30 includes the first flexible portion 31. The first flexible portion 31 is located on the back surface 12b of the brush plate 12 and covers the mounting holes b to shelter the mounting holes b. In this way, an outer surface of the electric toothbrush head 100 is ensured to be smooth, and the back surface 12b of the brush plate 12 is no longer uneven after being assembled, so as to avoid the phenomenon of dirt accumulation, thereby improving the convenience for cleaning. In addition, the root portions 21 of the bristles 20 can be protected, and thus the connection reliability of the bristles 20 can be improved. Furthermore, the hot melt connection is beneficial to the fixation of the bristles 20 and improves the processing convenience and connection reliability.

Alternatively, the bristles 20 are able to form a hot melt connection pad on the back surface 12b of the brush plate 12, and the hot melt connection pad extends to a peripheral region of the mounting holes b, and the first flexible portion 31 covers the hot melt connection pad. It can be understood that the bristles 20 pass through the mounting holes b. The hot melt connection pad, after being melted, is solidified with the bristles 20 to fix the root portions 21 of the bristles 20 on the brush plate 12. The first flexible portion 31 covers an outside of the hot melt connection pad. In this way, the bristles 20 are more stably arranged on the brush plate 12, and the unevenness of the outer surface of the electric toothbrush head 100 caused by the hot melt process is avoided, and thus the cleaning convenience is improved.

Alternatively, as shown in FIGS. 15 to 18, the brush plate 12 includes an annular rib 121 formed on the back surface 12b of the brush plate 12. The annular rib 121 extends along an edge of the brush plate 12 to form an inner region. The hot melt connection pad is located in the inner region of the annular rib 121. A thickness of the hot melt connection pad is equal to or smaller than a height of the annular rib 121, and the first flexible portion 31 covers the inner region of the annular rib 121 and extends out of the inner region of the annular rib 121. That is, the annular rib 121 is arranged on a periphery of the brush plate 12 to enclose a groove (i.e., the inner region). The hot melt connection pad is arranged in the groove, and rest parts in the groove are filled with the first flexible portion 31. An outer area of the groove is also covered by the first flexible portion 31. The height of the hot melt connection pad is smaller than or equal to the height of the annular rib 121 to enable the first flexible portion 31 to become thicker. In this way, the brush plate 12 can better exert elastic deformation, and the connection of the flexible member 30 and the brush plate 12 is more stable.

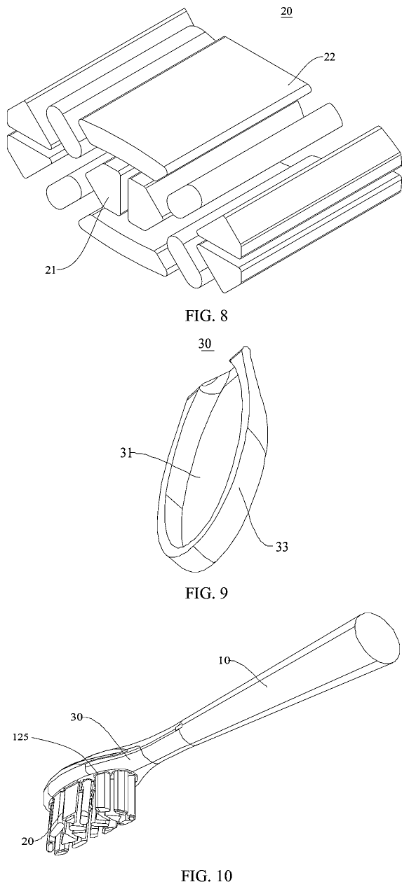

As shown in FIGS. 6 to 7, the brush plate 12 has a pre-hot-melted state and a post-hot-melted state. In the pre-hot-melted state, the back surface of the brush plate 12 includes a hot melting structure 122 around each of the mounting holes b, and the hot melting structure 122 includes a hot melting post. In the post-hot-melted state, the hot melt connection pad and the hot melting structure 122 are fused together as one piece.

In some embodiments, an orifice of the mounting hole b is chamfered to form a chamfered surface, which is inclined and extendable in a radial direction of the mounting hole b away from the mounting hole b towards the brush plate 12. The chamfered surface can provide a guide for the bristles 20 subjecting to hot melting to form the hot melt connection pad with an cross-sectional area larger than that of the mounting hole b. The brush plate 12 includes a plurality of hot melting posts provided at intervals on a periphery of the mounting hole b. The hot melting posts and the bristles 20 are fused together as one piece when being heated, so that the connection of the bristles 20 and the brush plate 12 is improved. Therefore, through the arrangement of the chamfered surface and/or the hot melting posts, after being hot melted, the bristles 20 and the brush plate 12 are fixed more stably, the phenomenon that the bristles 20 fall off during use of the electric toothbrush head 100 is avoided, and the use experience is improved.

Of course, the present disclosure is not limited thereto, and the bristles 20 may not be directly connected to the mounting holes b. For example, in some other embodiments, as shown in FIG. 11, at least one of the mounting holes b includes a mounting tube 50 provided therein. The root portion 21 of each bristle 20 is connected with an interior of the mounting tube 50, and the mounting tube 50 is elastic and deformable synchronously with the brush plate 12. Therefore, the provision of the mounting tube 50 can realize the installation of the bristle 20, and improve the stability of the connection between the bristle 20 and the brush plate 12. Since the mounting tube 50 is elastic and deformable synchronously with the brush plate 12, the brush plate 12 can be ensured to smoothly perform elastic deformation, and thus the arrangement of the mounting tube 50 forms less hindrance to the elastic deformation of the brush plate 12.

In addition, it should be noted that the mounting tube 50 may be completely embedded in a corresponding mounting hole b, or may be partially exposed outside the mounting hole b, which is not limited herein.

Further, the present disclosure also proposes an electric toothbrush. According to embodiments of the present disclosure, the electric toothbrush includes: a brush handle and a brush head assembly. The brush head assembly is the electric toothbrush head 100 according to any of the embodiments described above.

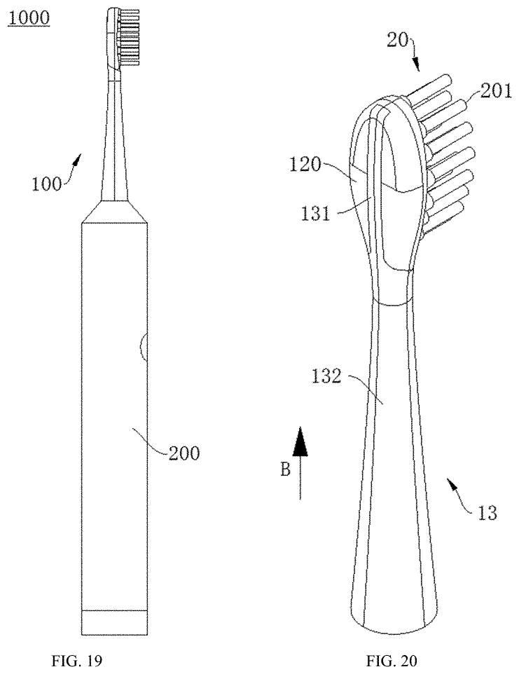

Referring now to FIGS. 19 to 24, an electric toothbrush head 100 and an electric toothbrush 1000 according to another embodiment of the present disclosure will be described.

Referring to FIG. 19, FIG. 19 is a schematic structural diagram of an electric toothbrush 1000 applied with an electric toothbrush head 100 according to another embodiment of the present disclosure.

Another embodiment of the present disclosure provides an electric toothbrush head 100 that provides both good cleaning and comfort of use. The power toothbrush head 100 can be applied to various power toothbrushes 1000, etc., and of course, the power toothbrush head 100 can be used independently. In some other alternative embodiments, the electric toothbrush head 100 can also be applied to conventional manual toothbrushes.

The electric toothbrush 1000 is a powered electric toothbrush, and when the electric toothbrush head 100 is applied to the electric toothbrush 1000, the electric toothbrush head 100 can be connected to the brush handle 200 of the electric toothbrush 1000 and the brush handle 200 is configured to drive the electric toothbrush head 100 to vibrate. Since the electric toothbrush 1000 adopts the electric toothbrush head 100 provided in the embodiments of the present disclosure, the electric toothbrush 1000 also provides good cleaning performance and comfort of use. In addition, when the electric toothbrush head 100 is applied to the electric toothbrush, the electric toothbrush head 100 can be connected to one end of the brush handle 200 of the electric toothbrush, such that the user can hold the brush handle 200 to drive the electric toothbrush head 100 to move, so as to complete the brushing action.

The structural composition, operation principles and advantageous effects of the electric toothbrush head 100 according to another embodiment of the present disclosure will be described in detail below.

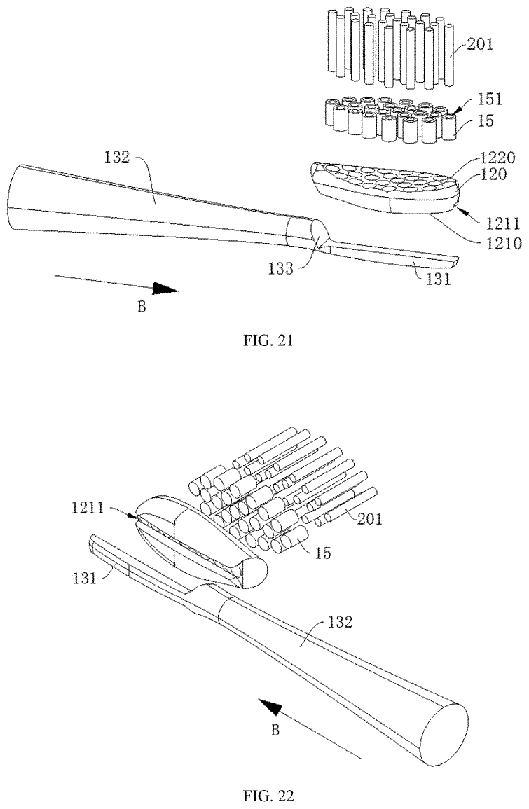

Referring to FIGS. 20, 21 and 22, FIG. 20 is a schematic perspective view of an electric toothbrush head 100 according to an embodiment of the present disclosure; FIG. 21 is a schematic exploded view of an electric toothbrush head 100 according to an embodiment of the present disclosure from a viewing angle; and FIG. 22 is a schematic exploded view of an electric toothbrush head 100 according to an embodiment of the present disclosure from another viewing angle. The electric toothbrush head 100 includes bristles 20, a connecting soft rubber 120 and a brush rod 13. One end of the brush rod 13 is connected to the connecting soft rubber 120, and the other end of the brush rod 13 is to be connected to the brush handle 200 of the electric toothbrush 1000. The brush rod 13 can transmit the vibration of the brush handle 200 to the connecting soft rubber 120. One end of the bristle 20 is connected to the connecting soft rubber 120, so that the bristle 20 is connected to the brush rod 13 through the connecting soft rubber 120. The connecting soft rubber 120 has a certain elasticity, so that the bristle 20 can swing relative to the brush rod 13 with a certain degree of freedom, and the bristle 20 cleans the teeth more gently, so as to improve the comfort of use. The vibration of the brush handle 200 can be transmitted to the bristles 20 through the brush rod 13 and the connecting soft rubber 120, so as to ensure that the bristles 20 have a better cleaning effect on the oral cavity.

Referring to FIGS. 21, 22 and 24, the brush rod 13 includes a first connecting segment 131 and a second connecting segment 132 that are connected to each other. One end of the second connecting segment 132 away from the first connecting segment 131 is configured to be connected to the brush handle 200 of the electric toothbrush 1000. The first connecting segment 131 is an elastic connecting segment, and the connecting soft rubber 120 is connected to the first connecting segment 131. An ability of the connecting soft rubber 120 to resist elastic deformation is smaller than an ability of the first connecting segment 131 to resist elastic deformation. Thus, the connecting soft rubber 120 is more prone to elastic deformation than the first connecting segment 131, and thus the bristles 20 can swing more easily relative to the first connecting segment 131 and a swing amplitude of the bristles 20 is also larger. Therefore, the contact between the bristles 20 and the teeth is gentler, and the freedom of movement of the bristles 20 is also greater, which is beneficial to improve the cleaning effect.

Further, the bristles 20 form a plurality of bristle bundles 201 arranged on the connecting soft rubber 120 at intervals. In other words, there is a gap between adjacent bristle bundles 201, and the gap provides a space for the bending of the adjacent bristle bundles 201, which is convenient for the bristle bundles 201 to be deformed according to the shape of the oral cavity. Therefore, the bristle bundles 201 can better fit the teeth, etc., and at the same time, it is also convenient to clean food residues between the adjacent bristle bundles 201. The first connecting segment 131 transmits the vibration of the brush handle 200 of the electric toothbrush 1000 to the connecting soft rubber 120, and then the connecting soft rubber 120 drives the bristle bundle 201 to vibrate. That is, the first connecting segment 131 can transmit the vibration of the brush handle 200 to the connecting soft rubber 120, and the connecting soft rubber 120 can transmit the vibration of the first connecting segment 131 to the bristle bundles 201. In addition, the bristle bundle 201 can move relative to the first connecting segment 131 through the deformation of the connecting soft rubber 120. In this way, when the electric toothbrush head 100 is used to brush teeth, even if the position of the first connecting segment 131 is fixed, the connecting soft rubber 120 can be deformed due to the deformability of the connecting soft rubber 120. Therefore, the position of the bristle bundles 201 can also be changeable, so that the bristles 20 better fit the teeth and provide effective action on the teeth. The relative positions between the plurality of bristle bundles 201 can be changed by the deformation of the connecting soft rubber 120, so that the plurality of bristle bundles 201 can fit the teeth from multiple angles, gently clean the teeth and the oral cavity in a comprehensive and all-direction way, thereby improving the cleaning effect. Further, since the connecting soft rubber 120 can be elastically deformed, the bristle bundle 201 can apply a softer force on the teeth, which is beneficial to improve the comfort of use. In addition, by the deformation of the connecting soft rubber 120, the vibration amplitude of the plurality of bristle bundles 201 is larger than the vibration amplitude of the brush rod 13, which is beneficial to shake the food residues off the teeth and improve the cleaning effect.

It should be noted that the connecting soft rubber 120 is made of flexible soft materials such as silica gel, rubber. The specific material of the connecting soft rubber 120 is not limited in the embodiments. In addition, the bristles 20 and the brush rod 13 are placed together in a mold, a soft rubber is injected between the brush rod 13 and the bristles 20 to form the connecting soft rubber 120, and the brush rod 13 and the bristles 20 are connected through the connecting soft rubber 120.

In addition, since both the first connecting segment 131 and the connecting soft rubber 120 have a certain elasticity, the electric toothbrush head 100 of the embodiments of the present disclosure can realize bending in various forms such as forward bending, backward bending, and lateral bending. Therefore, when brushing teeth, the bristles 20 can contact the teeth from multiple angles, so as to improve the cleaning effect.

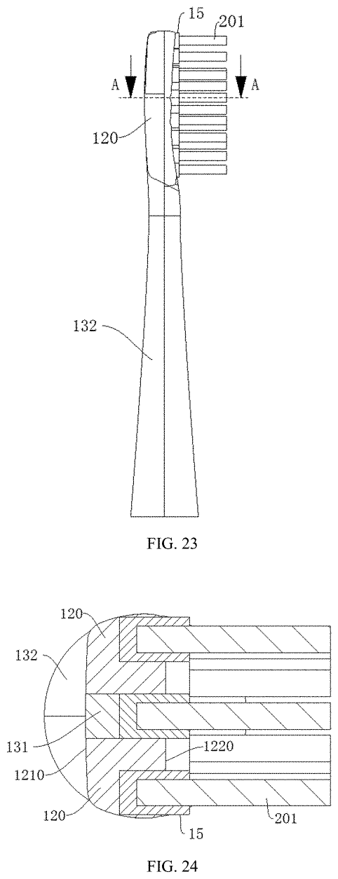

With continual reference to FIGS. 21 and 22 and FIGS. 23 and 24, FIG. 23 is a schematic structural diagram of an electric toothbrush head 100 according to an embodiment of the present disclosure, and FIG. 24 is a schematic structural sectional view taken along A-A in FIG. 23.

In the embodiment, the electric toothbrush head 100 further includes fixing rings 15. One end of the bristle bundle 201 is arranged in the fixing ring 15, and the fixing ring 15 is connected to the connecting soft rubber 120, thereby connecting the connecting soft rubber 120 and the bristles 20. There is a gap between adjacent fixing rings 15, and the gap provides a space for the bending of the adjacent bristle bundles 201, which is convenient for the bristle bundles 201 to deform according to the shape of the oral cavity. Therefore, the bristle bundles 201 can better fit the teeth, etc., and at the same time, it is also convenient to clean the food residues between the adjacent bristle bundles 201.

Specifically, the bristles 20 each have one end arranged in the fixing ring 15 to form a bristle bundle 201. The brush rod 13 and the bristles 20 after being fixed in the fixing ring 15 are placed into the mold together, and the soft rubber is injected between the brush rod 13 and the bristles 20 to form the connecting soft rubber 120, and the bristles 20 and the connecting soft rubber 120 are connected through the fixing ring 15. In this way, the bristles 20 are held in the fixing ring 15, thereby maintaining the shape of the bristle bundle 201. In other embodiments, the brush rod 13 can alternatively include fixing holes provided thereon for holding the bristles 20, and then the soft rubber is injected between the brush rod 13 and the bristles 20 to form the connecting soft rubber 120.

It should be noted that, in the embodiment, a plurality of fixing rings 15 are provided. The plurality of fixing rings 15 are distributed in the connecting soft rubber 120, and a plurality of bristle bundles 201 are in one-to-one correspondence with the plurality of fixing rings 15.

In addition, the manufacturing process of the electric toothbrush head 100 may include: forming a plurality of fixing rings 15 by injection molding, the fixing rings 15 being connected by connecting ribs formed in the injection molding; placing the plurality of fixing rings 15 that are connected to each other into a jig for bristles planting and die cutting, then planting the bristles 20 into the plurality of fixing rings 15, and removing the connecting ribs by die cutting; placing the fixing rings 15 with the planted bristles into a mold, and placing the brush rod 13 into the mold; and injecting a soft rubber between the brush rod 13 and the fixing rings 15 to form the connecting soft rubber 120 connecting the fixing rings 15 and the brush rod 13, so as to obtain an electric toothbrush head 100 with the bristles 20 having a certain degree of freedom.

In other embodiments, the manufacturing process of the electric toothbrush head 100 may include: forming a plurality of fixed rings 15 separated from each other by injection molding; placing the plurality of fixing rings 15 into a jig for bristles planting and die cutting, and then planting the bristles 20 into the plurality of fixing rings 15; placing the fixing rings 15 with the planted bristles 20 into a mold, and placing the brush rod 13 into the mold; and injecting a soft rubber between the brush rod 13 and the fixing rings 15 to form the connecting soft rubber 120 connecting the fixing ring 15 and the brush rod 13, so as to obtain an electric toothbrush head 100 with the bristles 20 having a certain degree of freedom.

Further, one end of each of the fixing rings 15 includes a bristle planting opening 151. The bristles 20 can be inserted into the fixing ring 15 through the bristle planting opening 151, and the bristle planting opening 151 is located outside the connecting soft rubber 120. In other words, the fixing ring 15 is partially located inside the connecting soft rubber 120, and partially located outside the connecting soft rubber 120, and the bristles 20 are located in the bristle planting opening 151, thereby separating the connecting soft rubber 120 from the bristles 20 through the fixing ring 15, reducing the negative influence of the process of forming the connecting soft rubber 120 through injection molding on the bristles 20, and maintaining the shape of the bristle bundle 201 formed from the bristles 20.

In an embodiment, one end of the fixing ring 15 protrudes from the surface of the connecting soft rubber 120. As shown in FIGS. 20 and 21, the end (i.e., an outer end) of the fixing ring 15 having the bristle planting opening 151 protrudes from the surface of the connecting soft rubber 120, thereby separating the connecting soft rubber 120 from the bristles 20 at the outer end of the fixing ring 15, and further reducing an adverse effect of the process of forming the connecting soft rubber 120 through injection molding process on the bristles 20.

In some embodiments, one end of the fixing ring 15 may have a bristle planting opening 151, and the bristles 20 may be inserted into the fixing ring 15 through the bristle planting opening 151, and one end of the fixing ring 15 away from the bristle planting opening 151 is a closed end. In other words, one end of the fixing ring 15 located in the connecting soft rubber 120 is a closed end so as to further retain the bristles 20 in the fixing ring 15, and further reduce the negative influence of the process of forming the connecting soft rubber 120 by injection molding on the bristles 20.

With further reference to FIGS. 21, 22 and 24, the first connecting segment 131 and the second connecting segment 132 are integrally molded as one piece, and a cross section of the first connecting segment 131 has a smaller area than a cross section of the second connecting segment 132. In this way, when the brush handle 200 drives the brush rod 13 to vibrate, the deformation of the first connecting segment 131 is larger than that of the second connecting segment 132, and the first connecting segment 131 has a smaller influence on the deformation of the connecting soft rubber 120, so that the connecting soft rubber 120 can have larger deformation than the second connecting segment 132, thereby ensuring that the bristles 20 can act on teeth softly in a better way. The cross section is a section cut perpendicularly to the longitudinal direction (i.e., the third direction B) of the brush rod 13.

A thickness of the first connecting segment 131 is smaller than a thickness of the second connecting segment 132, and a width of the first connecting segment 131 is smaller than a width of the second connecting segment 132. Thereby, the first connecting segment 131 has better deformation performance to reduce the influence on the deformation of the connecting soft rubber 120. The thickness directions of the first, second connecting segments 131 and 132 are the same as the direction indicated by the arrow A1 as shown in FIG. 4. The width directions of the first, second connecting segments 131 and 132 are the same as the direction indicated by the arrow A2 as shown in FIG. 5. The width direction is perpendicular to the longitudinal direction (i.e., the third direction) of the brush rod 13, and the thickness direction is perpendicular to the width direction and the longitudinal direction of the brush rod 13.

The connecting soft rubber 120 includes a first connecting surface 1210 and a second connecting surface 1220 which are opposite to each other. The bristles 20 extend out from the second connecting surface 1220, and the first connecting segment 131 is connected to the connecting soft rubber 120.

In some embodiments, the first connecting segment 131 is connected to the first connecting surface 1210. In this way, the connecting soft rubber 120 is arranged between the first connecting segment 131 and the bristles 20 to enlarge a distance between the bristles 20 and the first connecting segment 131. Therefore, an amplitude of swinging of the bristles 20 relative to the first connecting segment 131 is increased due to the softness of the connecting soft rubber 120, and the convenience for using the electric toothbrush head 100 is further improved.

In other embodiments, the first connecting segment 131 is exposed from the first connecting surface 1210, so that the connection between the first connecting segment 131 and the connecting soft rubber 120 is firmer, and thus a service life of the electric toothbrush head 100 is prolonged, and the vibration of the brush rod 13 can be effectively transmitted to the connecting soft rubber 120.

In other embodiments, the first connecting segment 131 is located between the first connecting surface 1210 and the second connecting surface 1220, and the first connecting segment 131 can extend into an interior of the connecting soft rubber 120, so that the connection between the first connecting segment 131 and the connecting soft rubber 120 is firmer, and thus a service life of the electric toothbrush head 100 is prolonged, and the vibration of the brush rod 13 can be effectively transmitted to the connecting soft rubber 120.

In the embodiments shown in FIGS. 19 to 23, the first connecting segment 131 is embedded in the connecting soft rubber 120 and connected to the connecting soft rubber 120, and a length of the first connecting segment 131 extending into the connecting soft rubber 120 exceeds 50% of a length of the connecting soft rubber 120 in the same direction as the longitudinal direction (i.e., the third direction) of the brush rod 13. Therefore, the first connecting segment 131 and the connecting soft rubber 120 are better connected, and the vibration of the brush rod 13 can be effectively transmitted to the connecting soft rubber 120.

Further, the first connecting surface 1210 may include a first connecting slot 1211 provided thereon, and the first connecting segment 131 is located in the first connecting slot 1211 and connected to an inner wall of the first connecting slot 1211. In other words, the connecting soft rubber 120 wraps a part of the first connecting segment 131, so as to improve stability of the connection of the first connecting segment 131 and the connecting soft rubber 120, and a projected area of the first connecting segment 131 on the first connecting surface 1210 is smaller than an area of the first connecting surface 1210, in other words, a cross-sectional area of the first connecting segment 131 is smaller than that of the first connecting surface 1210, as shown in FIG. 24, the connecting soft rubber 120 on upper and lower sides of the first connecting segment 131 is easily deformed, so as to increase an amplitude of swinging of the bristles 20 on the connecting soft rubber 120 around the first connecting segment 131, and further improve convenience for using the electric toothbrush head 100.

Referring to FIG. 21, the second connecting surface 1220 includes bristle mounting holes formed thereon, and the first connecting slot 1211 does not overlap the bristle mounting holes in a depth direction. The bristle mounting holes are spaced apart from each other, and one end of the fixing ring 15 is adapted to be arranged in the bristle mounting hole so as to ensure that the fixing ring 15 is correct in position and further ensure that the bristle bundle 201 is correct in position.

It should be noted that, in the embodiment, the first connecting segment 131 extends along the third direction, and two ends of the first connecting slot 1211 extend along the third direction and a direction opposite to the third direction, respectively. The first connecting slot 1211 penetrates through the connecting soft rubber 120, so as to facilitate the first connecting segment 131 to transmit a torque to the connecting soft rubber 120 to drive the bristles 20 on the connecting soft rubber 120 to move. In other embodiments, the first connecting slot 1211 may not penetrate through the connecting soft rubber 120, and a distal end of the first connecting segment 131 is connected to a side wall of the first connecting slot 1211, thereby reducing a probability of the distal end of the first connecting segment 131 injuring the oral cavity and improving the user experience.

In addition, in other embodiments, the first connecting segment 131 may alternatively be completely wrapped by the connecting soft rubber 120 and located inside the connecting soft rubber 120, so as to further reduce a probability that the first connecting segment 131 damages the oral cavity, and improve the use experience of the user.

Furthermore, one end of the second connecting segment 132 close to the first connecting segment 131 includes a connecting end surface 133, and both the first connecting segment 131 and the connecting soft rubber 120 are connected to the connecting end surface 133. In other words, a first part of the connecting end surface 133 is connected to the first connecting segment 131, and a second part of the connecting end surface 133 is connected to the connecting soft rubber 120, thereby facilitating the second connecting segment 132 to transmit the torque to the connecting soft rubber 120 and the first connecting segment 131 at the same time, and drive the bristles 20 on the connecting soft rubber 120 to move.

In addition, in the embodiment, an area of the second part of the connecting end surface 133 is larger than the cross-sectional area of the first connecting segment 131, thereby facilitating the second connecting segment 132 to transmit more torque to the soft connection rubber 120.

An operation principle of the electric toothbrush head 100 provided by the embodiment of the present disclosure is as follows.

The electric toothbrush head 100 includes the bristles 20, the connecting soft rubber 120 and the brush rod 13. One end of the brush rod 13 is connected to the connecting soft rubber 120, and the other end of the brush rod 13 is connected to the brush handle 200 of the electric toothbrush 1000. One end of each bristle 20 is connected to the connecting soft rubber 120. In this way, the bristles 20 are connected to the brush rod 13 through the connecting soft rubber 120, the bristles 20 can swing relative to the brush rod 13 with a certain degree of freedom, so the bristles 20 can better fit the teeth in the tooth brushing, and the use is more convenient. Further, the ability of the connecting soft rubber 120 to resist elastic deformation is smaller than the ability of the first connecting segment 131 to resist elastic deformation. Thus, when using the electric toothbrush head 100 to brush teeth, the connecting soft rubber 120 is more likely to drive the bristles 20 to swing, and an amplification of the vibration of the electric toothbrush head 100 is also greater, thereby improving the cleaning effect. In addition, the bristles 20 are connected to the connecting soft rubber 120, and a force that the bristles 20 exerts on the teeth is gentler, which is beneficial to further improve the cleaning effect of the electric toothbrush head 100 on the oral cavity, and further improve the comfort of use.

Referring to FIG. 19, the electric toothbrush 1000 according to another aspect of the present disclosure includes the brush handle 200 and the electric toothbrush head 100 according to the embodiment described above. Since the electric toothbrush 1000 adopts the electric toothbrush head 100 provided by the embodiment of the present disclosure, the electric toothbrush 1000 has both a good cleaning performance and the comfort of use.

The electric toothbrush according to the embodiment of the present disclosure adopts the above-mentioned brush head assembly, the brush handle vibrates to drive the brush plate 12 of the brush head assembly to swing relative to the brush handle, and the amplitude of the vibration of the brush plate part 12 is larger, which can improve the cleaning effect. The elasticity of the brush plate 12 and the flexibility of the flexible member 30 help buffer the reaction force of the tooth surface, so as to avoid the phenomenon of vibrating the hand, improve the user experience, avoid damage to the gums, and improve the safety of use.

Throughout this specification, descriptions with reference to “an embodiment”, “some embodiments”, “a schematic embodiment”, “an example”, “a specific example”, or “some examples” mean that the combination of a particular feature, structure, material, or characteristic described in the embodiment or example is included in at least one embodiment or example of the present disclosure. The schematic representations of the above terms are not necessarily referring to the same embodiment or example of the present disclosure. Furthermore, the described particular features, structures, materials, or characteristics may be combined in any suitable manner in one or more embodiments or examples.

Although embodiments of present disclosure have been shown and described above, those skilled in the art can understood that various changes, modifications, alternatives, and variations can be made to these embodiments without departing from the principles and ideas of the present disclosure. The scope of the present disclosure is defined by the claims and equivalents thereof.

What is claimed is:

1. An electric toothbrush head, comprising:
a brush head body comprising a brush rod and a brush plate, wherein the brush rod comprises a first end and a second end that are opposite to each other in a longitudinal direction of the brush rod; the brush plate is connected to the first end of the brush rod; the brush plate comprises a front surface and a back surface in a thickness direction of the brush plate; the brush plate is elastically deformable and has a non-deformed state and an elastically deformed state relative to the brush rod; an included angle between the brush plate and the brush rod is changeable within a range from 0 degrees to X degrees, and the X degrees are equal to or greater than 10 degrees; the elastically deformed state comprises a first deformed state and a second deformed state; the brush plate is bendable or deformable towards the front surface relative to the brush rod in the first deformed state, and the brush plate is bendable or deformable towards the back surface relative to the brush rod in the second deformed state; the second end of the brush rod is adapted to be connected to a brush handle of an electric toothbrush; and the brush rod is configured to transmit vibration generated at the brush handle of the electric toothbrush to the brush plate;
a plurality of bristles, wherein each of the plurality of bristles comprises a root portion and a head portion; the root portion and the head portion are respectively provided at two ends of each of the bristles along a longitudinal direction of the bristles; the root portion is connected to the brush plate, and the head portion is configured to extend out from the front surface of the brush plate; and
a flexible member, wherein a hardness of the flexible member is smaller than a hardness of the brush plate; and the flexible member comprises at least one of: a first flexible portion arranged on the back surface of the brush plate, a second flexible portion arranged on a peripheral side of the brush plate, or a third flexible portion arranged on the front surface of the brush plate.

2. The electric toothbrush head according to claim 1, wherein the flexible member comprises the first flexible portion and the second flexible portion; and a thickness of the second flexible portion is smaller than a thickness of the first flexible portion; and/or
the flexible member comprises the first flexible portion and the third flexible portion; and a thickness of the third flexible portion is smaller than the thickness of the first flexible portion.

3. The electric toothbrush head according to claim 1, satisfying one or more of:
a thickness of the first flexible portion is greater than ½ of a thickness of the brush plate;
the brush plate is a resilient brush plate that is bendable and twistable; or
a thickness of at least a part of the brush rod is greater than a maximum thickness of the brush plate.

4. The electric toothbrush head according to claim 1, wherein the flexible member comprises the first flexible portion and the second flexible portion; and the first flexible portion is configured to extend towards a peripheral side surface of the brush plate and be connected to the second flexible portion; and/or
the flexible member comprises the third flexible portion and the second flexible portion; and the third flexible portion is configured to extend towards the peripheral side surface of the brush plate and be connected to the second flexible portion.

5. The electric toothbrush head according to claim 4, wherein the flexible member comprises the first flexible portion, the second flexible portion, and the third flexible portion; and the flexible member is configured to wrap the brush plate.

6. The electric toothbrush head according to claim 1, wherein the flexible member comprises the first flexible portion; the brush rod comprises a groove portion formed on a back surface of the brush rod; the flexible member further comprises an extension portion filled in the groove portion and connected to the first flexible portion; and the groove portion comprises at least one flared section having a width increasing in a direction from the brush plate to the brush rod to prevent separation of the extension portion from the brush rod when the brush plate is elastically deformed.

7. The electric toothbrush head according to claim 6, wherein a width of the groove portion is decreased first and then increased in the direction from the brush plate to the brush rod.

8. The electric toothbrush head according to claim 1, wherein a cross-sectional area of an end of the brush plate connected to the brush rod is smaller than a cross-sectional area of the first end of the brush rod to allow for a cross-sectional abrupt change at a junction of the brush plate and the brush rod.

9. The electric toothbrush head according to claim 8, wherein the flexible member is partially arranged at the junction of the brush plate and the brush rod to smoothen an outer surface of the electric toothbrush head at the junction of the brush plate and the brush rod.

10. The electric toothbrush head according to claim 1, wherein the brush plate and the brush rod are integrally molded as one piece, and/or the brush plate is made of polystyrene; or
the brush plate and the brush rod are respectively molded; and the brush head body further comprises a connecting portion configured for connection of the brush plate and the brush rod.

11. The electric toothbrush head according to claim 10, wherein the connecting portion is arranged on the back surface of the brush plate; the connecting portion and the brush rod are integrally molded as one piece; and the flexible member is partially arranged between the connecting portion and the brush plate and is configured to connect the connecting portion and the brush plate; or
the connecting portion is arranged between the brush plate and the brush rod and is configured to connect the brush plate and the brush rod in the longitudinal direction of the brush rod; and an elastic deformability of the connecting portion is greater than an elastic deformability of any one of the brush plate and the brush rod.

12. The electric toothbrush head according to claim 1, wherein the brush plate has a plurality of mounting holes formed in the brush plate, and each of the plurality of mounting holes is configured to accommodate the root portion.

13. The electric toothbrush head according to claim 12, wherein the brush plate comprises a plurality of annular protrusions formed on the front surface of the brush plate; the plurality of mounting holes are arranged inside the plurality of annular protrusions, respectively; the flexible member comprises the third flexible portion; the third flexible portion comprises a plurality of avoidance holes formed in the third flexible portion; the plurality of avoidance holes are configured to allow the plurality of annular protrusions to pass through the plurality of avoidance holes; and a thickness of the third flexible portion is equal to or smaller than a height of each of the plurality of annular protrusions.

14. The electric toothbrush head according to claim 13, wherein the height of each of the plurality of annular protrusions is equal to or smaller than 2 mm; and/or the plurality of annular protrusions are soft.

15. The electric toothbrush head according to claim 12, wherein the mounting holes are through holes; the root portion of each of the plurality of bristles is connected to one of the plurality of mounting holes through hot melting; and the flexible member comprises the first flexible portion, and the first flexible portion is configured to cover the plurality of mounting holes.

16. The electric toothbrush head according to claim 15, wherein the plurality of bristles comprise a hot melt connection pad formed on the back surface of the brush plate; and the hot melt connection pad is configured to extend to a peripheral region of the plurality of mounting holes and be covered by the first flexible portion.

17. The electric toothbrush head according to claim 16, wherein the brush plate comprises an annular rib formed on the back surface of the brush plate; the annular rib is configured to extend along an edge of the brush plate to form an inner region; the hot melt connection pad is located in the inner region of the annular rib; a thickness of the hot melt connection pad is smaller than or equal to a height of the annular rib; and the first flexible portion is configured to cover the inner region of the annular rib and extend out of the inner region of the annular rib.

18. The electric toothbrush head according to claim 16, wherein the brush plate has a pre-melted state and a post-melted state; in the pre-melted state, the back surface of the brush plate comprises a hot melting structure surrounding each of the plurality of mounting holes, and the hot melting structure comprises a hot melting post; and in the post-melted state, the hot melt connection pad and the hot melting structure are fused together as one piece.

19. The electric toothbrush head according to claim 12, wherein at least one of the plurality of mounting holes comprises a mounting tube provided in the at least one of the mounting holes; the mounting tube is configured to accommodate the root portion of each of the bristles inside the mounting tube; and the mounting tube is an elastic tube and is elastically deformable synchronously with the brush plate.

20. An electric toothbrush, comprising:
a brush handle; and
a brush head assembly, wherein the brush head assembly is the electric toothbrush head according to claim 1.
